(19) United States
(12) Patent Application Publication
(10) Pub. No.: US 2026/0039188 A1
(43) Pub. Date: Feb. 5, 2026

(54) POWER CONVERSION CIRCUIT AND TOTEM POLE PFC CIRCUIT WITH FAST REVERSE VOLTAGE DETECTION

(71) Applicant: Chengdu Monolithic Power Systems Co., Ltd., Chengdu (CN)

(72) Inventors: Guangzhuo Li, Hangzhou (CN); Youtu Lin, Hangzhou (CN)

(21) Appl. No.: 19/284,467

(22) Filed: Jul. 29, 2025

(30) Foreign Application Priority Data
Jul. 30, 2024 (CN) 202411034965.2

(51) Int. Cl. H02M 1/088; H02M 1/00; H02M 1/42; H02M 7/219

(52) U.S. Cl. CPC H02M 1/088; H02M 1/0003; H02M 1/4208; H02M 7/219

(57) ABSTRACT

A control circuit for a power conversion circuit having a first input terminal and a second input terminal for receiving an AC input voltage is provided. The control circuit includes a first terminal, a second terminal, a driving terminal, and a detecting circuit. The detecting circuit is coupled to the first terminal and the second terminal to receive a first sampling voltage provided by a first sampling circuit and a second sampling voltage provided by a second sampling circuit. The first sampling circuit is coupled between the first input terminal and a reference ground. The second sampling circuit is coupled between the second input terminal and the reference ground. The detecting circuit provides a control signal to turn off a power switch of the power conversion circuit when it determines that the AC input voltage is abnormal based on the first sampling voltage and the second sampling voltage.

### CROSS-REFERENCE TO RELATED APPLICATIONS

This application claims the benefit of and priority to a CN application Ser. No. 202411034965.2, filed on Jul. 30, 2024, which is incorporated herein by reference into the present application.

### TECHNICAL FIELD

The present disclosure relates generally to electronic circuits, and more particularly but not exclusively to control circuits and methods for power conversion circuits and totem pole power factor correction (PFC) circuits.

### BACKGROUND OF THE INVENTION

Power conversion circuits have been widely applied to various industrial electronic devices and consumer electronic devices. By controlling the power switch of the power conversion circuit, a received AC input voltage can be converted to a DC output voltage to power a load.

When an abnormal event such as lightning strike, voltage surge or high-voltage spike occurs, the AC input voltage may suddenly reverse, thereby generating a reverse current that flows through the power switch, causing damage to the circuit.

### SUMMARY OF THE INVENTION

According to an embodiment of the present disclosure, a control circuit for a power conversion circuit is provided. The power conversion circuit has a first input terminal and a second input terminal for receiving an AC input voltage. The control circuit includes a first terminal, a second terminal, a driving terminal, and a detecting circuit. The first terminal receives a first sampling voltage from a first sampling circuit coupled between the first input terminal of the power conversion circuit and a reference ground. The second terminal receives a second sampling voltage from a second sampling circuit coupled between the second input terminal of the power conversion circuit and the reference ground. The driving terminal is coupled to a control terminal of a power switch of the power conversion circuit. The detecting circuit is coupled to the first terminal and the second terminal to receive the first sampling voltage and the second sampling voltage, determines whether the AC input voltage is abnormal based on the first sampling voltage and the second sampling voltage, and provides a control signal to turn off the power switch when the AC input voltage is determined to be abnormal.

According to another embodiment of the present disclosure, a control circuit for a totem pole PFC circuit is provided. The totem pole PFC circuit has a first input terminal and a second input terminal for receiving an AC input voltage. The control circuit includes a first terminal, a second terminal, a first driving terminal, a second driving terminal, and a detecting circuit. The first terminal receives a first sampling voltage from a first sampling circuit coupled between the first input terminal of the totem pole PFC circuit and a reference ground. The second terminal receives a second sampling voltage from a second sampling circuit coupled between the second input terminal of the totem pole PFC circuit and the reference ground. The first driving terminal is coupled to a control terminal of a first switch of the totem pole PFC circuit. The second driving terminal is coupled to a control terminal of a second switch of the totem pole PFC circuit. A first switching node formed by the first switch and the second switch is coupled to the first input terminal of the totem pole PFC circuit through an inductor. The detecting circuit is coupled to the first terminal and the second terminal to receive the first sampling voltage and the second sampling voltage, determines whether the AC input voltage is abnormal based on the first sampling voltage and the second sampling voltage, and provides a first control signal to turn off the first switch or a second control signal to turn off the second switch when the AC input voltage is determined to be abnormal.

According to yet another embodiment of the present disclosure, a method for controlling a power conversion circuit is provided. The power conversion circuit has a first input terminal and a second input terminal for receiving an AC input voltage. The method includes the following actions. A first sampling voltage is received from a first sampling circuit coupled between the first input terminal of the power conversion circuit and a reference ground. A second sampling voltage is received from a second sampling circuit coupled between the second input terminal of the power conversion circuit and the reference ground. The abnormality of the AC input voltage is determined based on the first sampling voltage and the second sampling voltage. A control signal is provided to turn off the power switch when the AC input voltage is determined to be abnormal.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 schematically shows a totem pole PFC circuit.

FIG. 2 schematically shows operating states of switches S1-S4 of the totem pole PFC circuit.

FIG. 3 schematically shows the direction of a reverse current when the AC input voltage changes from positive to negative suddenly.

FIG. 4 schematically shows another totem pole PFC circuit with a sense resistor.

FIG. 5 schematically shows a totem pole PFC circuit in accordance with one embodiment of the present disclosure.

FIG. 6 schematically shows simulated waveforms of signals of the totem pole PFC circuit shown in FIG. 5 in accordance with one embodiment of the present disclosure.

FIG. 7 schematically shows a detecting circuit in accordance with one embodiment of the present disclosure.

FIG. 8 schematically shows a first detecting circuit in accordance with one embodiment of the present disclosure.

FIG. 9 schematically shows a first detecting circuit in accordance with another embodiment of the present disclosure.

FIG. 10 schematically shows a second detecting circuit in accordance with one embodiment of the present disclosure.

FIG. 11 schematically shows waveforms of signals of the second detecting circuit shown in FIG. 10 in accordance with one embodiment of the present disclosure.

FIG. 12 schematically shows a detecting circuit in accordance with one embodiment of the present disclosure.

FIG. 13 schematically shows a second detecting circuit in accordance with one embodiment of the present disclosure.

FIG. 14 schematically shows a first sampling circuit and a second sampling circuit in accordance with one embodiment of the present disclosure.

FIG. 15 schematically shows a first sampling circuit and a second sampling circuit in accordance with another embodiment of the present disclosure.

FIG. 16 shows a flowchart of a method for controlling a power conversion circuit in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

In power conversion circuits, in order to improve circuit efficiency, the design of PFC topology is becoming more important. Conventional PFC topologies include full bridge PFC circuits, half bridge PFC circuits, and bridgeless PFC circuits. As one of the bridgeless PFC circuits, the totem pole PFC circuit has the advantages of low conduction losses and high efficiency.

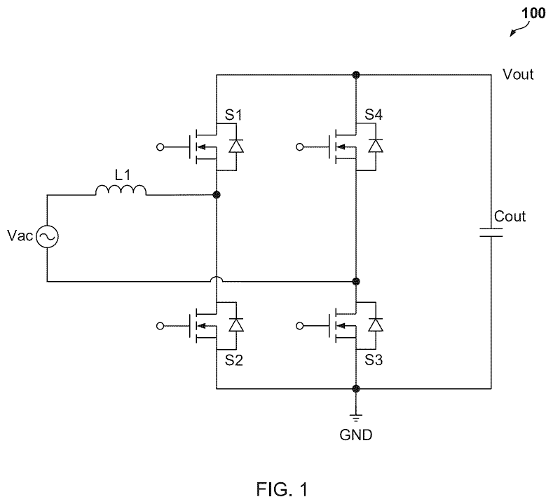

FIG. 1 schematically shows a totem pole PFC circuit 100. As shown in FIG. 1, the totem pole PFC circuit 100 includes an inductor L1, a first bridge arm, a second bridge arm, and an output capacitor Cout. The first bridge arm includes a first switch S1 and a second switch S2. The second bridge arm includes a third switch S3 and a fourth switch S4. By turning on and off of the switches S1-S4, the totem pole PFC circuit 100 converts an AC input voltage Vac to a DC output voltage Vout.

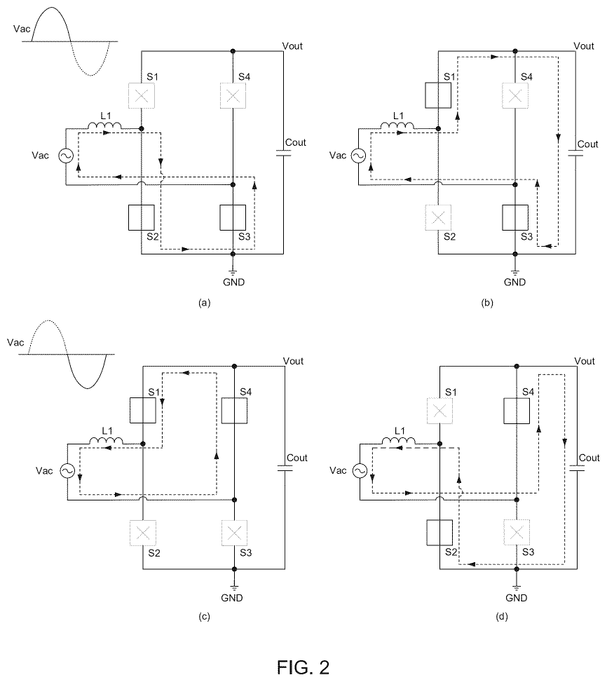

FIG. 2 schematically shows operating states of switches S1-S4 of the totem pole PFC circuit 100. When the AC input voltage Vac is in a positive half cycle, the third switch S3 is turned on, the fourth switch S4 is turned off, and the first switch S1 and the second switch S2 are turned on and off alternately. The current direction is shown in FIGS. 2(a) and 2(b). In FIG. 2(a), when the first switch S1 is turned off and the second switch S2 is turned on, the current flows through the inductor L1, the second switch S2 and the third switch S3. In FIG. 2(b), when the first switch S1 is turned on and the second switch S2 is turned off, the current flows through the inductor L1, the first switch S1, the output capacitor Cout and the third switch S3. When the AC input voltage Vac is in a negative half cycle, the third switch S3 is turned off, the fourth switch S4 is turned on, and the first switch S1 and the second switch S2 are turned on and off alternately. The current direction is shown in FIGS. 2(c) and 2(d). In FIG. 2(c), when the first switch S1 is turned on and the second switch S2 is turned off, the current flows through the fourth switch S4, the first switch S1 and the inductor L1. In FIG. 2(d), when the first switch S1 is turned off and the second switch S2 is turned on, the current flows through the fourth switch S4, the output capacitor Cout, the second switch S2 and the inductor L1.

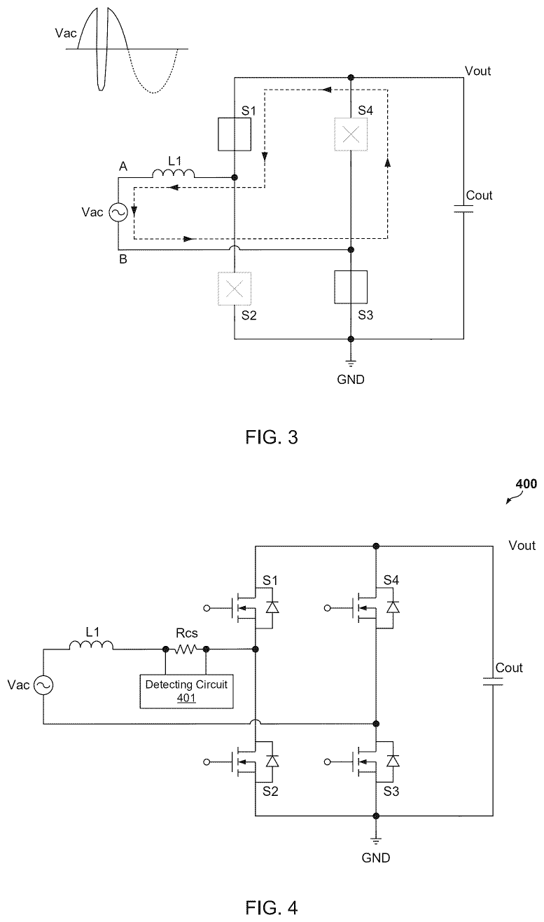

Taking the positive half cycle of the AC input voltage Vac as an example, FIG. 3 schematically shows the direction of a reverse current when the AC input voltage changes from positive to negative suddenly. When the AC input voltage Vac is in the positive half cycle, the third switch S3 is turned on and the fourth switch S4 is turned off. When the AC input voltage Vac suddenly changes from positive to negative, if the first switch S1 is turned on, the reverse current flows from a node B through the body diode of the fourth switch S4, the first switch S1 and the inductor L1 to a node A. As a result, the first switch S1 and the fourth switch S4 are damaged. Similarly, when the AC input voltage Vac is in the negative half cycle and suddenly changes from negative to positive, the reverse current may damage the second switch S2 and the third switch S3.

In order to protect the circuit, one common way is to use a sense resistor connected in series with the inductor L1 to obtain the voltage across the sense resistor, such that the change of the AC input voltage Vac could be indicated. Therefore, when the reverse AC input voltage Vac suddenly occurs, the switches in the reverse current loop could be turned off. FIG. 4 schematically shows another totem pole PFC circuit 400 with a sense resistor Rcs. As shown in FIG. 4, one terminal of the sense resistor Rcs is coupled to the AC input voltage Vac through the inductor L1, and the other terminal of the sense resistor Rcs is coupled to the DC output voltage Vout through the first switch S1. However, due to the AC input voltage Vac and the DC output voltage Vout are usually very high (e.g., Vac=265V, Vout=400V), a detecting circuit 401 requires a high voltage isolation device or a Hall device, resulting in the high cost of the circuit.

To address the above problems, the present disclosure provides control circuits and methods for power conversion circuits and totem pole PFC circuits. The control circuit could quickly detect the abnormal event of the AC input voltage Vac (e.g., the sudden reverse of the voltage direction), and when the abnormal event of the AC input voltage Vac is detected, the control circuit could turn off the power switch in the power conversion circuit timely to cut off the reverse current loop. Furthermore, in the embodiments of the present disclosure, without the high-voltage isolation device or the Hall device, the cost is reduced in addition to the circuit protection.

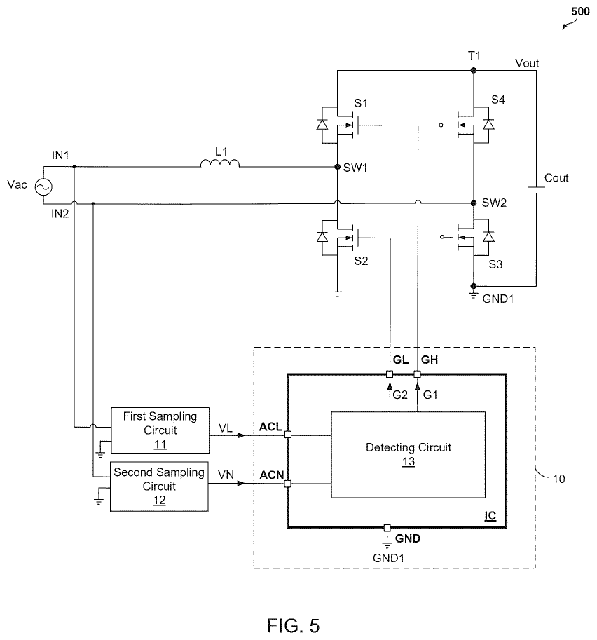

FIG. 5 schematically shows a totem pole PFC circuit 500 in accordance with one embodiment of the present disclosure. As shown in FIG. 5, the totem pole PFC circuit 500 has a first input terminal IN1 and a second input terminal IN2 configured to receive the AC input voltage Vac, and an output node T1 and a reference ground GND1 configured to provide the DC output voltage Vout. In the embodiment of FIG. 5, the totem pole PFC circuit 500 includes the first switch S1, the second switch S2, the third switch S3, the fourth switch S4, the inductor L1, and the output capacitor Cout. The first switch S1 is coupled between the output node T1 and a first switching node SW1. The second switch S2 is coupled between the first switching node SW1 and the reference ground GND1. The third switch S3 is coupled between a second switching node SW2 and the reference ground GND1. The fourth switch S4 is coupled between the output node T1 and the second switching node SW2. The inductor L1 is coupled between the first input terminal IN1 and the first switching node SW1. The output capacitor Cout is coupled between the output node T1 and the reference ground GND1. In the embodiment of FIG. 5, the switches S1-S4 are implemented by metal oxide semiconductor field effect transistors (MOSFETs).

As shown in FIG. 5, the totem pole PFC circuit 500 further includes a control circuit 10, a first sampling circuit 11 coupled between the first input terminal IN1 and the reference ground GND1, and a second sampling circuit 12 coupled between the second input terminal IN2 and the reference ground GND1. The control circuit 10 includes a plurality of terminals and a detecting circuit 13. In the embodiment shown in FIG. 5, the plurality of terminals includes a first terminal ACL, a second terminal ACN, a third terminal GND, a first driving terminal GH, and a second driving terminal GL. The first terminal ACL is configured to be coupled to an output terminal of the first sampling circuit 11 to receive a first sampling voltage VL. The second terminal ACN is configured to be coupled to an output terminal of the second sampling circuit 12 to receive a second sampling voltage VN. The third terminal GND is configured to be coupled to the reference ground GND1. The first driving terminal GH is configured to be coupled to the control terminal of the first switch S1. The second driving terminal GL is configured to be coupled to the control terminal of the second switch S2.

In the embodiment shown in FIG. 5, the detecting circuit 13 is configured to be coupled to the first terminal ACL and the second terminal ACN to receive the first sampling voltage VL and the second sampling voltage VN, respectively, and to determine whether the AC input voltage is abnormal based on the first sampling voltage VL and the second sampling voltage VN. When the detecting circuit 13 determines that the AC input voltage Vac is abnormal based on the first sampling voltage VL and the second sampling voltage VN, it provides a first control signal G1 or a second control signal G2 to turn off the first switch S1 or the second switch S2. As shown in FIG. 1, the detecting circuit 13 provides the first control signal G1 for controlling the first switch S1 and the second control signal G2 for controlling the second switch S2. The first control signal G1 is provided to the control terminal of the first switch S1 through the first driving terminal GH to control the first switch S1. The second control signal G2 is provided to the control terminal of the second switch S2 through the second driving terminal GL to control the second switch S2.

In the embodiment shown in FIG. 5, the control circuit 10 is configured as an integrated circuit (IC). In other embodiments, one of the first sampling circuit 11 and the second sampling circuit 12 is integrated with the detecting circuit 13 in the same IC. In yet another embodiment, both of the first sampling circuit 11 and the second sampling circuit 12 are integrated with the detecting circuit 13 in the same IC.

In the embodiment shown in FIG. 5, the working principle of the control circuit 10 is described with reference to the totem pole PFC circuit 500, and it will be understood by those skilled in the art that this is not intended to limit the present disclosure. It should be understood that, the control circuit 10 is also applicable for other suitable AC-DC power conversion circuits. The power switches of the power conversion circuit (e.g., the first switch S1 and the second switch S2 in the totem pole PFC circuit 500) may also utilize other suitable controllable semiconductor devices, such as JFETs, IGBTs, SiC devices, or GaN devices.

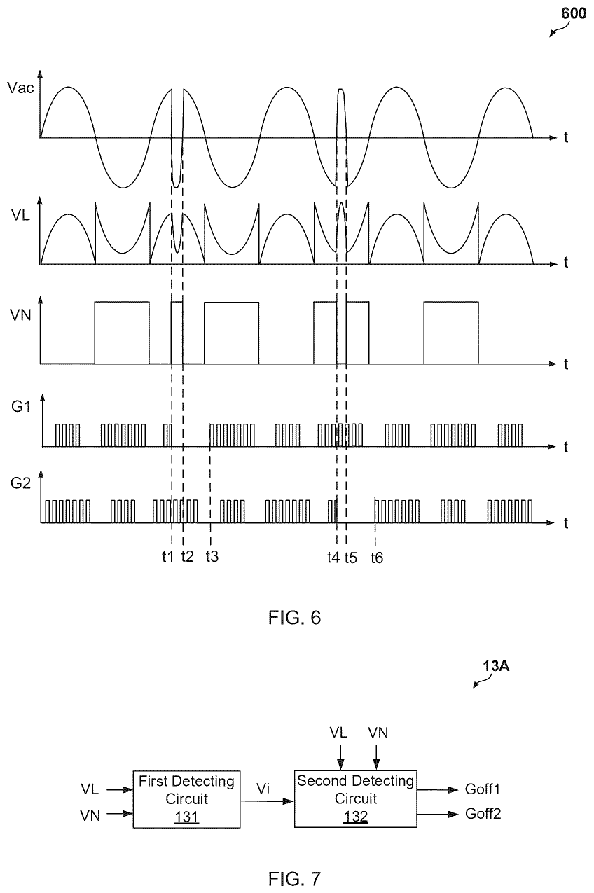

FIG. 6 schematically shows simulated waveforms 600 of signals of the totem pole PFC circuit 500 shown in FIG. 5 in accordance with one embodiment of the present disclosure. As shown in FIG. 6, under normal condition (e.g., before time t1), the AC input voltage Vac shows a sinusoidal waveform shape having a positive half cycle and a negative half cycle. Under abnormal condition, the AC input voltage Vac may reverse in a very short time, for instance, the AC input voltage Vac may abruptly change from positive to negative in the positive half cycle (e.g., from time t1 to time t2 shown in FIG. 6) or abruptly change from negative to positive in the negative half cycle (e.g., from time t4 to time t5 shown in FIG. 6). The working principle of the totem pole PFC circuit 500 is illustrated below with reference to the FIGS. 5 and 6.

At time t1, when the first sampling voltage VL is lower than the second sampling voltage VN in the positive half cycle of the AC input voltage Vac, the detecting circuit 13 determines that the AC input voltage Vac is abnormal. The first control signal G1 changes from a high level to a low level, the first switch S1 is turned off, thereby cutting off the reverse current loop. In one embodiment, the detecting circuit 13 allows the first switch S1 to turn on when the AC input voltage Vac enters a subsequent negative half cycle. For example, at time t3, the first control signal G1 changes from the low level to the high level, the first switch S1 is turned on. In other embodiments, the detecting circuit 13 allows the first switch S1 to turn on after several half cycles of the AC input voltage Vac pass by according to the practical application requirements.

At time t4, when the first sampling voltage VL is higher than the second sampling voltage VN in the negative half cycle of the AC input voltage Vac, the detecting circuit 13 determines that the AC input voltage Vac is abnormal. The second control signal G2 changes from a high level to a low level, the second switch S2 is turned off, thereby cutting off the reverse current loop. In one embodiment, the detecting circuit 13 allows the second switch S2 to turn on when the AC input voltage Vac enters a subsequent positive half cycle. For example, at time t6, the second control signal G2 changes from the low level to the high level, the second switch S2 is turned on. In other embodiments, the detecting circuit 13 allows the second switch S2 to turn on after several half cycles of the AC input voltage Vac pass by according to the practical application requirements.

FIG. 7 schematically shows a detecting circuit 13A in accordance with one embodiment of the present disclosure. As shown in FIG. 7, the detecting circuit 13A includes a first detecting circuit 131 and a second detecting circuit 132. The first detecting circuit 131 is configured to provide an input voltage digital signal Vi indicating the AC input voltage Vac based on the first sampling voltage VL and the second sampling voltage VN. The second detecting circuit 132 is configured to provide a first off control signal Goff1 and a second off control signal Goff2 based on the input voltage digital signal Vi, the first sampling voltage VL and the second sampling voltage VN. When the input voltage digital signal Vi indicates that the AC input voltage Vac is in the positive half cycle or the negative half cycle, the second detecting circuit 132 is configured to compare the first sampling voltage VL with the second sampling voltage VN to determine whether to turn off the first switch S1 or the second switch S2. To be specific, when the input voltage digital signal Vi indicates that the AC input voltage Vac is in the positive half cycle, if the first sampling voltage VL is lower than the second sampling voltage VN, the second detecting circuit 132 provides the first off control signal Goff1 to turn off the first switch S1. When the input voltage digital signal Vi indicates that the AC input voltage Vac is in the negative half cycle, if the first sampling voltage VL is higher than the second sampling voltage VN, the second detecting circuit 132 provides the second off control signal Goff2 to turn off the second switch S2.

In one embodiment, the input voltage digital signal Vi indicates the actual value of the AC input voltage Vac and changes along with the change of the AC input voltage Vac received from the first input terminal IN1 and the second input terminal IN2. In one embodiment, the detecting circuit 13A generates the first control signal G1 based on the first off control signal Goff1 to turn off the first switch S1, and the second control signal G2 based on the second off control signal Goff2 to turn off the second switch S2.

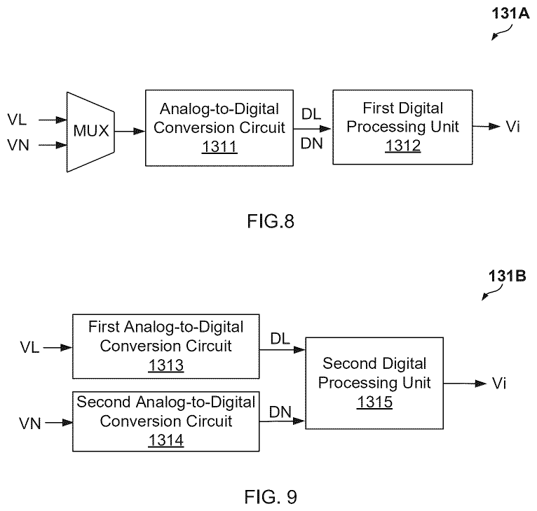

FIG. 8 schematically shows a first detecting circuit 131A in accordance with one embodiment of the present disclosure. As shown in FIG. 8, the first detecting circuit 131A includes a multiplexer MUX, an analog-to-digital conversion circuit 1311, and a first digital processing unit 1312. The multiplexer MUX has a first input terminal, a second input terminal, and an output terminal. The first input terminal of the multiplexer MUX is configured to receive the first sampling voltage VL and the second input terminal of the multiplexer MUX is configured to receive the second sampling voltage VN. The multiplexer MUX is configured to provide the first sampling voltage VL or the second sampling voltage VN at its output terminal selectively. The analog-to-digital conversion circuit 1311 has an input terminal and an output terminal. The input terminal of the analog-to-digital conversion circuit 1311 is configured to be coupled to the output terminal of the multiplexer MUX. The analog-to-digital conversion circuit is configured to provide a first digital signal DL indicative of the first sampling voltage VL and a second digital signal DN indicative of the second sampling voltage VN at its output terminal selectively. The first digital processing unit 1312 is configured to provide the input voltage digital signal Vi based on the first digital signal DL and the second digital signal DN. In one implementation, the first digital processing unit 1312 is configured to perform a subtraction operation to obtain the input voltage digital signal Vi indicating the AC input voltage Vac, that is, the second digital signal DN indicating the second sampling voltage VN is subtracted from the first digital signal DL indicating the first sampling voltage VL. In one embodiment, the analog-to-digital conversion circuit 1311 includes an analog-to-digital converter (ADC).

FIG. 9 schematically shows a first detecting circuit 131B in accordance with another embodiment of the present disclosure. As shown in FIG. 9, the first detecting circuit 131B includes a first analog-to-digital conversion circuit 1313, a second analog-to-digital conversion circuit 1314, and a second digital processing unit 1315. The first analog-to-digital conversion circuit 1313 has an input terminal configured to receive the first sampling voltage VL and an output terminal configured to provide the first digital signal DL indicating the first sampling voltage VL. The second analog-to-digital conversion circuit 1314 has an input terminal configured to receive the second sampling voltage VN and an output terminal configured to provide the second digital signal DN indicating the second sampling voltage VN. The second digital processing unit 1315 is configured to provide the input voltage digital signal Vi indicating the AC input voltage Vac based on the first digital signal DL and the second digital signal DN. In one implementation, the second digital processing unit 1315 is configured to perform a subtraction operation to obtain the input voltage digital signal Vi indicating the AC input voltage Vac, that is, the second digital signal DN indicating the second sampling voltage VN is subtracted from the first digital signal DL indicating the first sampling voltage VL. In an embodiment, the first analog-to-digital conversion circuit 1313 is implemented by an ADC, and the second analog-to-digital conversion circuit 1314 is implemented by another ADC.

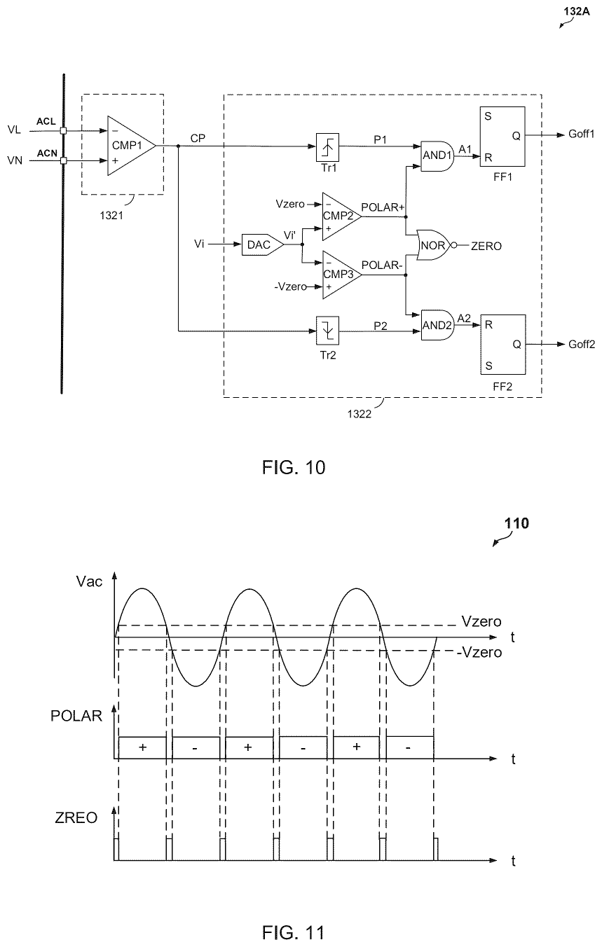

FIG. 10 schematically shows a second detecting circuit 132A in accordance with one embodiment of the present disclosure. As shown in FIG. 10, the second detecting circuit 132A includes a comparing circuit 1321 and a logic circuit 1322. The comparing circuit 1321 has a first input terminal, a second input terminal, and an output terminal. The first input terminal of the comparing circuit 1321 is configured to be coupled to the first terminal ACL to receive the first sampling voltage VL. The second input terminal of the comparing circuit 1321 is configured to be coupled to the second terminal ACN to receive the second sampling voltage VN. The comparing circuit 1321 is configured to compare the first sampling voltage VL with the second sampling voltage VN, and to provide a comparison signal CP at its output terminal. The logic circuit 1322 is configured to provide the first off control signal Goff1 and the second off control signal Goff2 based on the input voltage digital signal Vi and the comparison signal CP to control the first switch S1 and the second switch S2, respectively.

In the embodiment of FIG. 10, the comparing circuit 1321 includes a comparator CMP1 having a non-inverting input terminal, an inverting input terminal and an output terminal. The non-inverting input terminal is configured to be coupled to the second terminal ACN to receive the second sampling voltage VN, the inverting input terminal is configured to be coupled to the first terminal ACL to receive the first sampling voltage VL. The comparator CMP1 is configured to generate the comparison signal CP at the output terminal. When the first sampling voltage VL is lower than the second sampling voltage VN, the comparison signal CP is at a high level. When the first sampling voltage VL is higher than the second sampling voltage VN, the comparison signal CP is at a low level.

In the embodiment of FIG. 10, when the reverse AC input voltage Vac suddenly occurs, since the comparing circuit 1321 receives the first sampling voltage VL and the second sampling voltage VN directly, the comparison operation on the first sampling voltage VL and the second sampling voltage VN is performed by the comparing circuit 1321 directly without waiting for the conversion process and/or output results of the analog-to-digital conversion circuit, the reverse AC input voltage Vac could be detected immediately. Subsequently, the abnormal information of the AC input voltage Vac indicated by the comparison signal CP is provided to the logic circuit 1322 so that the first switch S1 or the second switch S2 could be turned off timely. For example, when the input voltage digital signal Vi indicates that the AC input voltage Vac is in the positive half cycle and the comparison signal CP changes from the low level to the high level, the logic circuit 1322 provides the first off control signal Goff1 to turn off the first switch S1. For another example, when the input voltage digital signal Vi indicates that the AC input voltage Vac is in the negative half cycle and the comparison signal CP changes from the high level to the low level, the logic circuit 1322 provides the second off control signal Goff2 to turn off the second switch S2.

In the embodiment of FIG. 10, the logic circuit 1322 includes a rising edge flip flop Tr1, a falling edge flip flop Tr2, a digital-to-analog converter DAC, a comparator CMP2, a comparator CMP3, a AND gate AND1, a AND gate AND2, a NOR gate NOR, a flip flop FF1 and a flip flop FF2. The rising edge flip flop Tr1 is configured to be coupled to the output terminal of the comparing circuit 1321 to receive the comparison signal CP, and to provide a pulse signal P1 when the rising edge of the comparison signal CP arrives. The digital-to-analog converter DAC is configured to convert the input voltage digital signal Vi to an input voltage analog signal Vi′. The comparator CMP2 is configured to compare the input voltage analog signal Vi′ with a positive voltage threshold Vzero, and to provide a positive polarity signal POLAR+based on the comparison result. The AND gate AND1 performs logic AND operation on the pulse signal P1 and the positive polarity signal POLAR+, and provides an operation result A1. The flip flop FF1 turns off the first switch S1 based on the operation result A1. The falling edge flip flop Tr2 is configured to be coupled to the output terminal of the comparing circuit 1321 to receive the comparison signal CP, and to provide a pulse signal P2 when the falling edge of the comparison signal CP arrives. The comparator CMP3 is configured to compare the input voltage analog signal Vi′ with a negative voltage threshold-Vzero, and to provide a negative polarity signal POLAR-based on the comparison result. The AND gate AND2 performs logic AND operation on the pulse signal P2 and the negative polarity signal POLAR− and provides the operation result A2. The flip flop FF2 turns off the second switch S2 based on the operation result A2. The NOR gate NOR is configured to provide a zero region signal ZERO based on the positive polarity signal POLAR+ and the negative polarity signal POLAR−. In one embodiment, the positive voltage threshold Vzero may approach but be slightly higher than zero, and the negative voltage threshold-Vzero may approach but be slightly lower than zero.

It should be appreciated that, the logic circuit 1322 shown in FIG. 10 is just for exemplary and illustrative purposes, and not intended to be limiting. In other embodiments, the logic circuit 1322 may include other different components/devices to realize the corresponding function.

FIG. 11 schematically shows waveforms 110 of signals of the second detecting circuit 132A shown in FIG. 10 in accordance with one embodiment of the present disclosure. As shown in FIG. 11, the positive polarity signal POLAR+ is enabled (e.g., at a high level) when the AC input voltage Vac indicated by the input voltage digital signal Vi is higher than the positive voltage threshold Vzero. The negative polarity signal POLAR− is enabled (e.g., at a high level) when the AC input voltage Vac indicated by the input voltage digital signal Vi is lower than the negative voltage threshold-Vzero. The zero region signal ZERO is enabled (e.g., at a high level) when the AC input voltage Vac indicated by the input voltage digital signal Vi is between the positive voltage threshold Vzero and the negative voltage threshold-Vzero. In one embodiment, when the zero region signal ZERO is enabled, the first switch S1 and the second switch S2 are turned off.

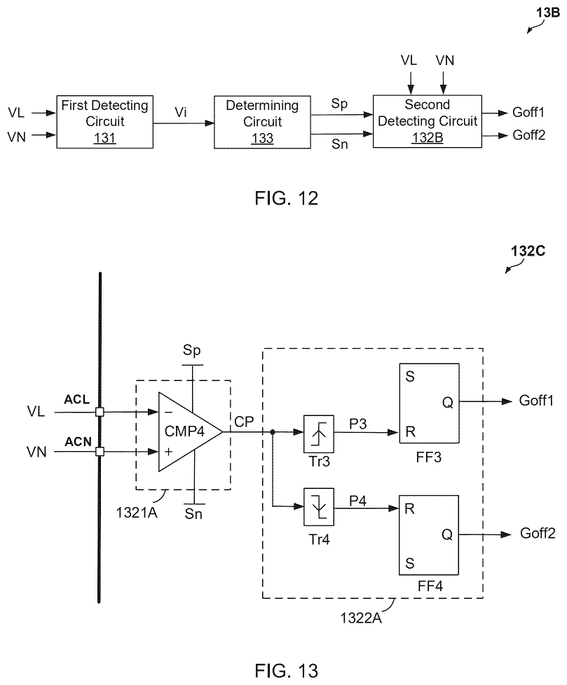

FIG. 12 schematically shows a detecting circuit 13B in accordance with one embodiment of the present disclosure. Compared with the detecting circuit 13A shown in FIG. 7, the detecting circuit 13B further includes a determining circuit 133. Based on the input voltage digital signal Vi, the determining circuit 133 is configured to generate a first indicating signal Sp to indicate that the AC input voltage Vac is in the positive half cycle, and a second indicating signal Sn to indicate that the AC input voltage Vac is in the negative half cycle. For instance, when the difference between the first sampling voltage VL and the second sampling voltage VN is higher than the positive voltage threshold Vzero, the input voltage digital signal Vi indicates that the AC input voltage Vac is in the positive half cycle, and the first indicating signal Sp provided by the determining circuit 133 is enabled (e.g., at a high level). When the difference between the first sampling voltage VL and the second sampling voltage VN is lower than the negative voltage threshold-Vzero, the input voltage digital signal Vi indicates that the AC input voltage Vac is in the negative half cycle, and the second indicating signal Sn provided by the determining circuit 133 is enabled (e.g., at a high level).

The second detecting circuit 132B is configured to compare the first sampling voltage VL with the second sampling voltage VN to determine whether to turn off the first switch S1 or the second switch S2 when the first indicating signal Sp or the second indicating signal Sn is enabled. To be specific, when the first indicating signal Sp is enabled, if the first sampling voltage VL is lower than the second sampling voltage VN, the second detecting circuit 132B provides the first off control signal Goff1 to turn off the first switch S1. When the second indicating signal Sn is enabled, if the first sampling voltage VL is higher than the second sampling voltage VN, the second detecting circuit 132B provides the second off control signal Goff2 to turn off the second switch S2.

FIG. 13 schematically shows a second detecting circuit 132C in accordance with one embodiment of the present disclosure. As shown in FIG. 13, the second detecting circuit 132C includes a comparing circuit 1321A and a logic circuit 1322A. The comparing circuit 1321A has a first input terminal, a second input terminal, a first enable terminal, a second enable terminal, and an output terminal. The first input terminal of the comparing circuit 1321A is coupled to the first terminal ACL to receive the first sampling voltage VL, and the second input terminal the comparing circuit 1321A is coupled to the second terminal ACN to receive the second sampling voltage VN. The first enable terminal receives the first indicating signal Sp, and the second enable terminal receives the second indicating signal Sn. When the first indicating signal Sp or the second indicating signal Sn is enabled, the comparing circuit 1321A is configured to compare the first sampling voltage VL with the second sampling voltage VN, and to provide the comparison signal CP at the output terminal. The logic circuit 1322A is configured to determine whether to turn off the first switch S1 or the second switch S2 based on the comparison signal CP. To be specific, when the comparison signal CP changes from the low level to the high level, the logic circuit 1322A provides the first off control signal Goff1 to turn off the first switch S1. When the comparison signal CP changes from the high level to the low level, the logic circuit 1322A provides the second off control signal Goff2 to turn off the second switch S2.

In the embodiment of FIG. 13, the comparing circuit 1321A includes a comparator CMP4 having a non-inverting input terminal, an inverting input terminal, a first enable terminal and a second enable terminal. The non-inverting input terminal of the comparing circuit 1321A is configured to be coupled to the second terminal ACN to receive the second sampling voltage VN. The inverting input terminal of the comparing circuit 1321A is configured to be coupled to the first terminal ACL to receive the first sampling voltage VL. The first enable terminal of the comparing circuit 1321A is configured to receive the first indicating signal Sp. The second enable terminal of the comparing circuit 1321A is configured to receive the second indicating signal Sn. When the first indicating signal Sp or the second indicating signal Sn is enabled, the comparator CMP4 is configured to compare the first sampling voltage VL with the second sampling voltage VN to generate the comparison signal CP at the output terminal.

In the embodiment of FIG. 13, the logic circuit 1322A includes a rising edge flip flop Tr3, a falling edge flip flop Tr4, a flip flop FF3, and a flip flop FF4. The rising edge flip flop Tr3 is configured to be coupled to the output terminal of the comparing circuit 1321A to receive the comparison signal CP, and to provide a pulse signal P3 when the rising edge of the comparison signal CP arrives. The flip flop FF3 is configured to turn off the first switch S1 based on the pulse signal P3. The falling edge flip flop Tr4 is configured to be coupled to the output terminal of the comparing circuit 1321A to receive the comparison signal CP, and to provide a pulse signal P4 when the falling edge of the comparison signal CP arrives. The flip flop FF4 is configured to turn off the second switch S2 based on the pulse signal P4.

It should be appreciated that, the logic circuit 1322A shown in FIG. 13 is just for exemplary and illustrative purposes and not intended to be limiting. In other embodiments, the logic circuit 1322A may include other different components/devices to realize the corresponding function.

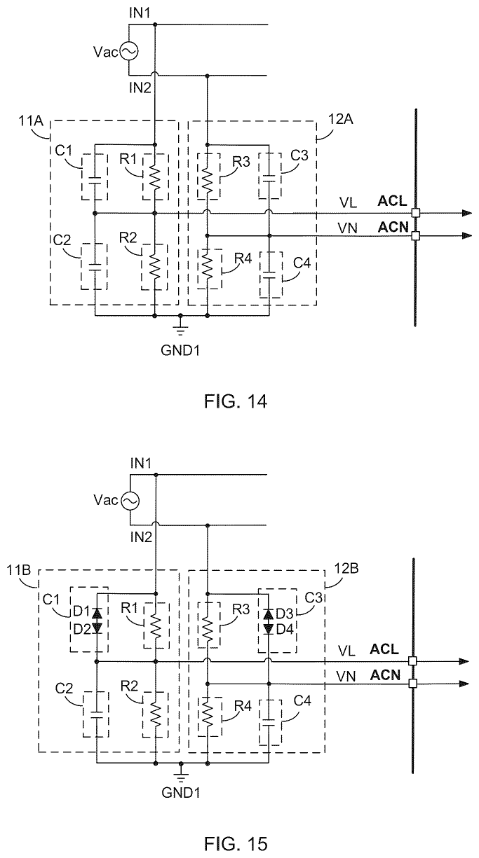

FIG. 14 schematically shows a first sampling circuit 11A and a second sampling circuit 11B in accordance with one embodiment of the present disclosure. As shown in FIG. 14, the first sampling circuit 11A includes a first resistor-capacitor voltage divider. The first resistor-capacitor voltage divider includes a resistive element R1, a capacitive element C1, a resistive element R2, and a capacitive element C2. The resistive element R1 has a first terminal configured to be coupled to the first input terminal IN1, and a second terminal configured to be coupled to the first terminal ACL. In other words, the second terminal of the resistive element R1 functions as the output terminal of the first sampling circuit 11A. The capacitive element C1 is configured to be coupled in parallel with the resistive element R1. The resistive element R2 has a first terminal configured to be coupled to the second terminal of the first resistive element R1, and a second terminal configured to be coupled to the reference ground GND1. The capacitive element C2 is configured to be coupled in parallel with the resistive element R2.

The second sampling circuit 12A includes a second resistor-capacitor voltage divider. The second resistor-capacitor voltage divider includes a resistive element R3, a capacitive element C3, a resistive element R4, and a capacitive element C4. The resistive element R3 has a first terminal configured to be coupled to the second input terminal IN2, and a second terminal configured to be coupled to the second terminal ACN. In other words, the second terminal of the resistive element R3 functions as the output terminal of the second sampling circuit 12A. The capacitive element C3 is configured to be coupled in parallel with the resistive element R3. The resistive element R4 has a first terminal configured to be coupled to the second terminal of the first resistive element R3, and a second terminal configured to be coupled to the reference ground GND1. The capacitive element C4 is configured to be coupled in parallel with the resistive element R4.

In the embodiment as shown in FIG. 14, the resistive elements R1-R4 are implemented by resistors, and the capacitive elements C1-C4 are implemented by capacitors. It should be appreciated that each of the resistive elements R1-R4 may include one resistor as shown in FIG. 14 or may include a plurality of resistors coupled in series. Each of the capacitive elements C1-C4 may include one capacitor as shown in FIG. 14, or may include a plurality of capacitors coupled in parallel, or may be a parasitic capacitance of a device. In some other embodiments, the resistive elements R1-R4 may include any suitable elements with resistive characteristics, and the capacitive elements C1-C4 may include any suitable elements with capacitive characteristics.

FIG. 15 schematically shows a first sampling circuit 11B and a second sampling circuit 12B in accordance with another embodiment of the present disclosure. Compared with FIG. 14, in FIG. 15, the capacitive element C1 includes two diodes D1 and D2 coupled in series, and the capacitive element C3 includes two diodes D3 and D4 coupled in series. In one embodiment, the anode of the diode D1 is coupled to the anode of the diode D2, and the anode of the diode D3 is coupled to the anode of the diode D4.

In the embodiment of FIG. 14, when the reverse AC input voltage Vac suddenly occurs, the capacitive element C1 would charge or discharge the capacitive element C2 in a very short time (e.g., <100 ns) so that the first sampling voltage VL could follow the change of the AC input voltage Vac timely. Similarly, the capacitive element C3 would charge or discharge the capacitive element C4 in a very short time (e.g., <100 ns) so that the second sampling voltage VN could follow the change of the AC input voltage Vac timely. Moreover, compared with the conventional method that uses an analog-to-digital conversion circuit and/or a digital processing unit, the comparator (e.g., 1321 or 1321A) in the embodiment of the present disclosure could indicate the change of the AC input voltage Vac more quickly by comparing the first sampling voltage VL and the second sampling voltage VN directly. As a result, the control circuit 10 is able to obtain the abnormal information of the AC input voltage Vac faster and turn off the first switch S1 or the second switch S2 timely, thereby preventing the reverse current from damaging the circuit. Meanwhile, the embodiments of the present disclosure do not require either the high voltage isolation device or the Hall device, which reduce the cost of the circuit.

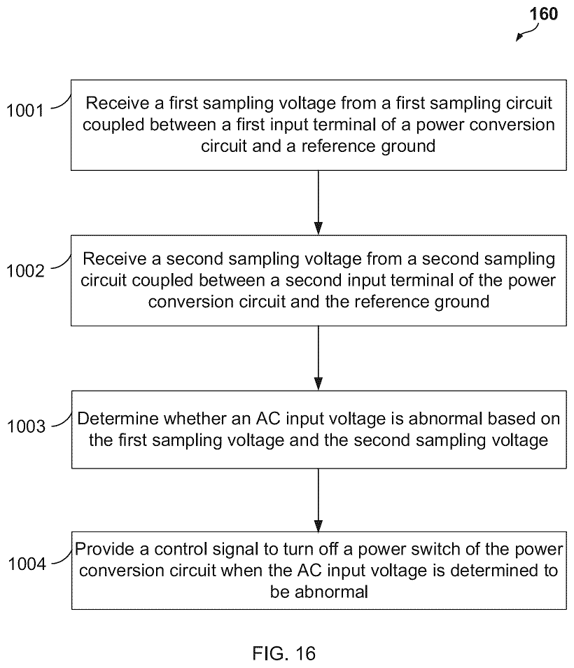

FIG. 16 shows a flowchart of a method 160 for controlling a power conversion circuit in accordance with one embodiment of the present disclosure. The power conversion circuit has a first input terminal and a second input terminal for receiving an AC input voltage, an output node and a reference ground for providing a DC output voltage, and a power switch. The method 160 includes actions 1001-1004.

In action 1001, a first sampling voltage is received from a first sampling circuit coupled between the first input terminal of the power conversion circuit and the reference ground.

In action 1002, a second sampling voltage is received from a second sampling circuit coupled between the second input terminal of the power conversion circuit and the reference ground.

In action 1003, the abnormality of the AC input voltage is determined based on the first sampling voltage and the second sampling voltage.

In action 1004, a control signal is provided to turn off the power switch when the AC input voltage is determined to be abnormal.

In one embodiment, action 1003 includes the following action. The AC input voltage is determined to be abnormal when the first sampling voltage is lower than the second sampling voltage in a positive half cycle of the AC input voltage.

In one embodiment, action 1003 includes the following action. The AC input voltage is determined to be abnormal when the first sampling voltage is higher than the second sampling voltage in a negative half cycle of the AC input voltage.

In one embodiment, the first sampling circuit includes a first resistor-capacitor voltage divider. The first resistor-capacitor voltage divider includes a first resistive element, a first capacitive element, a second resistive element, and a second capacitive element. The first resistive element has a first terminal configured to be coupled to the first input terminal of the power conversion circuit and a second terminal. The first capacitive element is configured to be coupled in parallel with the first resistive element. The second resistive element has a first terminal configured to be coupled to the second terminal of the first resistive element, and a second terminal configured to be coupled to the reference ground. The second capacitive element is configured to be coupled in parallel with the second resistive element. In one embodiment, the first capacitive element includes a capacitor. In another embodiments, the first capacitive element includes two diodes coupled in series.

In one embodiment, the AC input voltage is in the positive half cycle when the difference between the first sampling voltage and the second sampling voltage is higher than a positive voltage threshold. The AC input voltage is in the negative half cycle when the difference between the first sampling voltage and the second sampling voltage is lower than a negative voltage threshold. In one embodiment, the positive voltage threshold may approach but be slightly higher than zero, and the negative voltage threshold may approach but be slightly lower than zero.

In one embodiment, the power conversion circuit includes a totem pole PFC circuit. In other embodiments, the power conversion circuit includes other suitable AC-DC conversion circuits.

It is noted that in the flow charts described above, the functions labelled in the boxes shown in FIG. 16 can also occur in a different sequence. For example, two consecutive blocks, in fact, can be executed substantially concurrently, or they may sometimes be executed in the reverse order, depending upon the particular function involved.

In the present invention, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a power conversion circuit having a first input terminal and a second input terminal for receiving an AC input voltage, the control circuit comprising:
a first terminal configured to receive a first sampling voltage from a first sampling circuit coupled between the first input terminal of the power conversion circuit and a reference ground;
a second terminal configured to receive a second sampling voltage from a second sampling circuit coupled between the second input terminal of the power conversion circuit and the reference ground;
a driving terminal configured to be coupled to a control terminal of a power switch of the power conversion circuit; and
a detecting circuit configured to be coupled to the first terminal and the second terminal to receive the first sampling voltage and the second sampling voltage, to determine whether the AC input voltage is abnormal based on the first sampling voltage and the second sampling voltage, and to provide a control signal to turn off the power switch when the AC input voltage is determined to be abnormal.

2. The control circuit of claim 1, wherein:
when the first sampling voltage is lower than the second sampling voltage in a positive half cycle of the AC input voltage, the AC input voltage is determined to be abnormal.

3. The control circuit of claim 2, wherein:
when the AC input voltage enters a subsequent negative half cycle, the control signal is provided to turn on the power switch.

4. The control circuit of claim 1, wherein:
when the first sampling voltage is higher than the second sampling voltage in a negative half cycle of the AC input voltage, the AC input voltage is determined to be abnormal.

5. The control circuit of claim 1, wherein the detecting circuit comprises:
a first detecting circuit configured to provide an input voltage digital signal indicating the AC input voltage based on the first sampling voltage and the second sampling voltage; and
a second detecting circuit configured to compare the first sampling voltage with the second sampling voltage to determine whether to provide an off control signal to turn off the power switch when the input voltage digital signal indicates that the AC input voltage is in a positive half cycle or a negative half cycle.

6. The control circuit of claim 5, wherein the first detecting circuit comprises:
a multiplexer configured to receive the first sampling voltage and the second sampling voltage, and to provide the first sampling voltage and the second sampling voltage selectively;
an analog-to-digital conversion circuit configured to be coupled to the multiplexer, and to provide a first digital signal indicating the first sampling voltage and a second digital signal indicating the second sampling voltage selectively; and
a first digital processing unit configured to provide the input voltage digital signal indicating the AC input voltage based on the first digital signal and the second digital signal.

7. The control circuit of claim 5, wherein the second detecting circuit comprises:
a comparing circuit configured to receive the first sampling voltage and the second sampling voltage, and to compare the first sampling voltage with the second sampling voltage to provide a comparison signal; and
a logic circuit configured to determine whether to provide the off control signal to turn off the power switch based on the input voltage digital signal and the comparison signal.

8. The control circuit of claim 1, wherein the first sampling circuit comprises a first resistor-capacitor voltage divider, and wherein the first resistor-capacitor voltage divider comprises:
a first resistive element having a first terminal and a second terminal, wherein the first terminal of the first resistive element is configured to be coupled to the first input terminal of the power conversion circuit and the second terminal of the first resistive element is configured to be coupled to the first terminal of the control circuit;
a first capacitive element configured to be coupled in parallel with the first resistive element;
a second resistive element having a first terminal and a second terminal, wherein the first terminal of the second resistive element is configured to be coupled to the second terminal of the first resistive element and the second terminal of the second resistive element is configured to be coupled to the reference ground; and
a second capacitive element configured to be coupled in parallel with the second resistive element.

9. The control circuit of claim 8, wherein the first capacitive element comprises a capacitor.

10. The control circuit of claim 8, wherein the first capacitive element comprises two diodes connected in series.

11. A control circuit for a totem pole power factor correction (PFC) circuit having a first input terminal and a second input terminal for receiving an AC input voltage, the control circuit comprising:
a first terminal configured to receive a first sampling voltage from a first sampling circuit coupled between the first input terminal of the totem pole PFC circuit and a reference ground;
a second terminal configured to receive a second sampling voltage from a second sampling circuit coupled between the second input terminal of the totem pole PFC circuit and the reference ground;
a first driving terminal configured to be coupled to a control terminal of a first switch of the totem pole PFC circuit;
a second driving terminal configured to be coupled to a control terminal of a second switch of the totem pole PFC circuit, wherein a first switching node formed by the first switch and the second switch is coupled to the first input terminal of the totem pole PFC circuit through an inductor; and
a detecting circuit configured to be coupled to the first terminal and the second terminal to receive the first sampling voltage and the second sampling voltage, to determine whether the AC input voltage is abnormal based on the first sampling voltage and the second sampling voltage, and to provide a first control signal to turn off the first switch or a second control signal to turn off the second switch when the AC input voltage is determined to be abnormal.

12. The control circuit of claim 11, wherein:
when the first sampling voltage is lower than the second sampling voltage in a positive half cycle of the AC input voltage, the AC input voltage is determined to be abnormal; and
when the first sampling voltage is higher than the second sampling voltage in a negative half cycle of the AC input voltage, the AC input voltage is determined to be abnormal.

13. The control circuit of claim 11, wherein the detecting circuit comprises:
a first detecting circuit configured to provide an input voltage digital signal indicating the AC input voltage based on the first sampling voltage and the second sampling voltage;
a determining circuit configured to generate a first indicating signal and a second indicating signal based on the input voltage digital signal, wherein the first indicating signal is configured to indicate that the AC input voltage is in a positive half cycle, and the second indicating signal is configured to indicate that the AC input voltage is in a negative half cycle; and
a second detecting circuit configured to compare the first sampling voltage with the second sampling voltage to determine whether to provide a first off control signal to turn off the first switch when the first indicating signal is enabled or a second off control signal to turn off the second switch when the second indicating signal is enabled.

14. The control circuit of claim 13, wherein the second detecting circuit comprises:
a comparing circuit having a first input terminal, a second input terminal, a first enable terminal, a second enable terminal, and an output terminal, wherein the first input terminal is configured to be coupled to the first terminal of the control circuit to receive the first sampling voltage, the second input terminal is configured to be coupled to the second terminal of the control circuit to receive the second sampling voltage, the first enable terminal is configured to receive the first indicating signal, the second enable terminal is configured to receive the second indicating signal, and the comparing circuit is configured to compare the first sampling voltage with the second sampling voltage to provide a comparison signal at the output terminal when the first indicating signal or the second indicating signal is enabled.

15. The control circuit of claim 11, wherein the second sampling circuit comprises a second resistor-capacitor voltage divider, and wherein the second resistor-capacitor voltage divider comprises:
a first resistive element having a first terminal and a second terminal, wherein the first terminal is configured to be coupled to the second input terminal of the totem pole PFC circuit and the second terminal is configured to be coupled to the second terminal of the control circuit;
a first capacitive element configured to be coupled in parallel with the first resistive element;
a second resistive element having a first terminal and a second terminal, wherein the first terminal is configured to be coupled to the second terminal of the first resistive element and the second terminal is configured to be coupled to the reference ground; and
a second capacitive element configured to be coupled in parallel with the second resistive element.

16. A method for controlling a power conversion circuit having a first input terminal and a second input terminal for receiving an AC input voltage, the method comprising:
receiving a first sampling voltage from a first sampling circuit coupled between the first input terminal of the power conversion circuit and a reference ground;
receiving a second sampling voltage from a second sampling circuit coupled between the second input terminal of the power conversion circuit and the reference ground;
determining whether the AC input voltage is abnormal based on the first sampling voltage and the second sampling voltage; and
providing a control signal to turn off a power switch of the power conversion circuit when the AC input voltage is determined to be abnormal.

17. The method of claim 16, wherein:
when the first sampling voltage is lower than the second sampling voltage in a positive half cycle of the AC input voltage, the AC input voltage is determined to be abnormal.

18. The method of claim 16, wherein:
when the first sampling voltage is higher than the second sampling voltage in a negative half cycle of the AC input voltage, the AC input voltage is determined to be abnormal.

19. The method of claim 16, wherein the first sampling circuit comprises a resistor-capacitor voltage divider, and wherein the first resistor-capacitor voltage divider comprises:
a first resistive element having a first terminal and a second terminal, wherein the first terminal of the first resistive element is configured to be coupled to the first input terminal of the power conversion circuit;
a first capacitive element configured to be coupled in parallel with the first resistive element;
a second resistive element having a first terminal and a second terminal, wherein the first terminal of the second resistive element is configured to be coupled to the second terminal of the first resistive element and the second terminal of the second resistive element is configured to be coupled to the reference ground; and
a second capacitive element configured to be coupled in parallel with the second resistive element.

20. The method of claim 19, wherein the first capacitive element comprises a capacitor.
